(19) United States
(12) Patent Application Publication
(10) Pub. No.: US 2025/0231282 A1
(43) Pub. Date: Jul. 17, 2025

(54) APPARATUS, SYSTEM, AND METHOD OF RADAR SIMULATION

(71) Applicant: MobilEye Vision Technologies Ltd., Jerusalem (IL)

(72) Inventors: Ilia Yoffe, Hod Hasharon (IL); Eyal Naftaly Glick, Petah Tikva (IL); Ishai Aharoni, Holon (IL); Yossef Tsfaty, Rishon Le Zion (IL); Ophir Shabtay, Tsofit (IL)

(73) Assignee: MobilEye Vision Technologies Ltd., Jerusalem (IL)

(21) Appl. No.: 19/021,753

(22) Filed: Jan. 15, 2025

Related U.S. Application Data
(60) Provisional application No. 63/621,491, filed on Jan. 16, 2024.

(51) Int. Cl. G01S 7/40; G01S 13/931

(52) U.S. Cl. CPC G01S 7/4095; G01S 13/931

(57) ABSTRACT

For example, a radar simulator may be configured to determine simulated radar information corresponding to a simulated scene for a simulated radar system, for example, by processing simulated scene information corresponding to the simulated scene, for example, based on a path loss model and one or more Point Spread Functions (PSFs). For example, the path loss model may represent a path loss of radar signals transmitted by one or more transmitters of the simulated radar system and received by one or more receivers of the simulated radar system. For example, the one or more PSFs may correspond to one or more radar processing procedures applied by the simulated radar system. For example, the radar simulator may be configured to provide an output based on the simulated radar information.

### CROSS REFERENCE

This application claims the benefit of and priority from U.S. Provisional Patent Application No. 63/621,491 entitled “APPARATUS, SYSTEM, AND METHOD OF SIMULATION TESTING”, filed Jan. 16, 2024, the entire disclosure of which is incorporated herein by reference.

### BACKGROUND

Simulation testing techniques may be utilized for testing and validating control systems, for example, vehicle control systems and/or any other control systems.

For example, Software-in-the-loop (SIL) testing techniques may be utilized for testing and validating software, e.g., of vehicle control systems and/or any other systems, for example, to quickly and cost-effectively identify any problems and/or to improve the quality of the software.

For example, Hardware-in-the-Loop (HIL) testing techniques may be utilized to validate Electronic Control Units (Embedded Control Units) (ECUs), e.g., automotive ECUs, for example, using simulation and/or modeling techniques, e.g., to shorten test times and/or to increase testing coverage.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of components and operations of a system for simulation testing, in accordance with some demonstrative aspects.

FIG. 3 is a schematic illustration of a method of generating simulated radar information, in accordance with some demonstrative aspects.

FIG. 4A and FIG. 4B are schematic illustrations of a radar simulation technique to simulate radar information, in accordance with some demonstrative aspects.

FIG. 5 is a schematic illustration of a radar simulation path, and a full radar signal-level simulation path, in accordance with some demonstrative aspects.

FIG. 6 is a schematic illustration of a method of radar simulation, in accordance with some demonstrative aspects.

FIG. 7 is a schematic illustration of a product, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by, or in connection with, a computer or any instruction execution system. For example, a computer-usable or computer-readable medium may be or may include any apparatus that can contain, store, communicate, propagate, and/or transport the program for use by or in connection with the instruction execution system, apparatus, and/or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled, directly or indirectly, to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may include one or more wired or wireless links, may utilize one or more components of wireless communication, may utilize one or more methods or protocols of wireless communication, or the like. Some aspects may utilize wired communication and/or wireless communication.

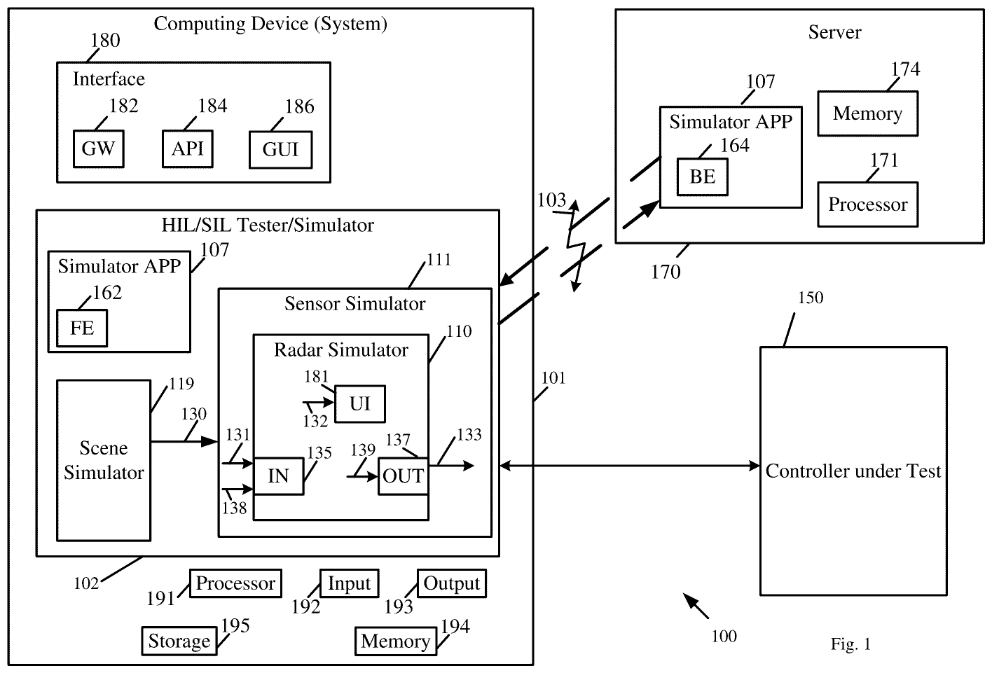

Reference is made to FIG. 1, which schematically illustrates a system 100, in accordance with some demonstrative aspects.

In some demonstrative aspects, system 100 may include a simulator (also referred to as “tester”, “test simulator”, or “testing station”) 102, which may be configured to test a controller under test 150, e.g., as described below.

In some demonstrative aspects, simulator 102 may include a Software-in-the-Loop (SIL) simulator (also referred to as “SIL tester” or “SIL testing station”) 102, which may be configured to test software and/or code of the controller under test 150, e.g., as described below.

In some demonstrative aspects, simulator 102 may include a Hardware-in-the-Loop (HIL) simulator (also referred to as “HIL tester” or “HIL testing station”) 102, which may be configured to test an Electronic Control Unit (Embedded Control Unit) (ECU) under test 150, e.g., as described below.

In some demonstrative aspects, the controller under test 150 may include an automotive controller, e.g., as described below.

In some demonstrative aspects, the controller under test 150 may include a vehicle system controller to control one or more vehicular systems of a vehicle.

In some demonstrative aspects, the controller under test 150 may include a controller of an autonomous vehicle or an assisted vehicle.

In some demonstrative aspects, the controller under test 150 may include an Advanced Driver Assistance Systems (ADAS) and/or an Autonomous Vehicle (AV) (ADAS/AV) controller, which may be configured to control one or more ADAS/AV functionalities.

In some demonstrative aspects, the controller under test 150 may be implemented as part of a vehicular system, for example, a system to be implemented and/or mounted in a vehicle.

In one example, the controller under test 150 may be implemented as part of an autonomous vehicle system, an automated driving system, an assisted vehicle system, a driver assistance and/or support system, and/or the like.

In other aspects, the controller under test 150 may include any other additional or alternative type of controller for use in any other suitable device and/or system, e.g., a robot device or system, a drone device or system, or the like.

In some demonstrative aspects, one or more operations and/or functionalities of simulator 102 may be implemented by one or more elements of a computing system including one or more computing devices 101.

For example, the computing device 101 may be implemented using suitable hardware components and/or software components, for example, processors, controllers, memory units, storage units, input units, output units, communication units, operating systems, applications, or the like.

In some demonstrative aspects, the computing device 101 may include, for example, one or more of a processor 191, an input unit 192, an output unit 193, a memory unit 194, and/or a storage unit 195. The computing device 101 may optionally include other suitable hardware components and/or software components. In some demonstrative aspects, some or all of the components of one or more of the computing device 101 may be enclosed in a common housing or packaging, and may be interconnected or operably associated using one or more wired or wireless links. In other aspects, components of the computing device 101 may be distributed among multiple or separate devices.

In some demonstrative aspects, the processor 191 may include, for example, a Central Processing Unit (CPU), a Digital Signal Processor (DSP), a GPU, an FPGA, a Microcontroller Unit (MCU), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller.

In some demonstrative aspects, the input unit 192 may include, for example, a keyboard, a keypad, a mouse, a touch-screen, a touch-pad, a track-ball, a stylus, a microphone, or other suitable pointing device or input device. The output unit 193 may include, for example, a monitor, a screen, a touch-screen, a Light Emitting Diode (LED) display unit, a flat panel display, a Liquid Crystal Display (LCD) display unit, a plasma display unit, one or more audio speakers or earphones, or other suitable output devices.

In some demonstrative aspects, the memory unit 194 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. The storage unit 195 may include, for example, a hard disk drive, a Solid State Drive (SSD), or other suitable removable or non-removable storage units. For example, the memory unit 194 and/or the storage unit 195, for example, may store data processed by the computing device 101.

In some demonstrative aspects, the computing device 101 may be configured to communicate with one or more other devices via at least one network, e.g., a wireless and/or wired network.

In some demonstrative aspects, the network 103 may include a wired network, a communication bus, a local area network (LAN), a wireless LAN (WLAN) network, a radio network, a cellular network, a Wireless Fidelity (Wi-Fi) network, a Bluetooth (BT) network, and/or the like.

In some demonstrative aspects, the computing device 101 may be configured to perform and/or to execute one or more operations, modules, processes, procedures, and/or the like, e.g., as described below.

In some demonstrative aspects, one or more operations and/or functionalities of simulator 102 may be implemented by at least one simulator application 107, which may be implemented by, as part of, and/or in the form of, at least one service, module, and/or controller, e.g., as described below.

In some demonstrative aspects, the simulator application 107 may include, or may be implemented as, software, a software module, an application, a program, a subroutine, instructions, an instruction set, computing code, words, values, symbols, and/or the like.

In some demonstrative aspects, the simulator application 107 may include a local application to be executed by the computing device 101 implementing the simulator 102.

In some demonstrative aspects, the memory unit 194 and/or storage unit 195 of the computing device 101 may store instructions resulting in the simulator application 107, and/or the processor 191 may be configured to execute the instructions resulting in the simulator application 107 and/or to perform one or more calculations and/or processes of the simulator application 107, e.g., as described below.

In other aspects, the simulator application 107 may include a remote application to be executed by a suitable computing system, e.g., a server 170.

In some demonstrative aspects, the server 170 may include at least a remote server, a web-based server, a cloud server, and/or any other server.

In some demonstrative aspects, the computing device 101 implementing the simulator 102 may communicate with the server 170, for example, via the network 103.

In some demonstrative aspects, the server 170 may include a suitable memory and/or storage unit 174 having stored thereon instructions resulting in the simulator application 107, and a suitable processor 171 to execute the instructions.

In some demonstrative aspects, the simulator application 107 may include a combination of a remote application and a local application.

In one example, the simulator application 107 may be downloaded and/or received by the computing device 101 from another computing system, e.g., the server 170, such that the simulator application 107 may be executed locally by the computing device 101 implementing the simulator 102. For example, some or all of the instructions of the simulator application 107 may be received and stored, e.g., temporarily, in a memory or any suitable short-term memory or buffer of the computing device 101 implementing the simulator 102, e.g., prior to being executed by the processor 191 of the computing device 101.

In another example, the simulator application 107 may include a frontend (FE) 162 to be executed locally by the computing device 101 implementing the simulator 102, and a backend (BE) 164 to be executed by the server 170. For example, the frontend 107 may include and/or may be implemented as a local application, a web application, a web site, a web client, e.g., a Hypertext Markup Language (HTML) web application, or the like.

For example, one or more first operations of the simulator application 107 may be performed locally, for example, by the computing device 101 implementing the simulator 102, and/or one or more second operations of the simulator application 107 may be performed remotely, for example, by the server 170.

In other aspects, the simulator application 107 may include and/or may be implemented by any other suitable computing arrangement and/or scheme.

In some demonstrative aspects, simulator 102 may be configured to perform one or more operations and/or functionalities of a simulation (testing) mechanism, e.g., a synthetic testing mechanism, which may be configured to provide a technical solution to support validation of SW and/or HW solutions intended for production vehicles, e.g., as described below.

In some demonstrative aspects, simulator 102 may be configured to perform one or more operations and/or functionalities of a simulation (testing) mechanism, which may be configured to provide a technical solution to simulate operations and/or functionalities, with which the controller under test 150 may be configured to interact.

In some demonstrative aspects, simulator 102 may be configured to perform one or more operations and/or functionalities of a simulation (testing) mechanism, e.g., a SIL simulation (testing) mechanism and/or a HIL simulation (testing) mechanism, which may be configured to provide a technical solution to support testing and/or validation, e.g., of relatively complex systems.

In some demonstrative aspects, the SIL simulation (testing) mechanism and/or a HIL simulation (testing) mechanism may be implemented as part of a closed loop decision system, e.g., a driving simulator. For example, in the closed loop decision system, an action, e.g., a driving action, which may be performed, for example, for a given scenario of a scene at a specific frame, may have an effect on the scene to be generated for a next frame.

In some demonstrative aspects, simulator 102 may be configured to perform one or more operations and/or functionalities of a simulation (testing) mechanism, which may be configured to provide a technical solution to simulate operations and/or functionalities, with which the controller under test 150 may be configured to interact.

For example, the simulation (testing) mechanism may be configured to provide a technical solution to support the controller under test 150, which is being stimulated by the testing station 102, in using the same exact configuration, for example, SW and/or HW, e.g., as will be running inside the vehicle once deployed for production.

In some demonstrative aspects, the simulation (testing) mechanism may be configured to provide a technical solution to support reliable injection of one or more sensor models, for example, under a constraint of keeping the SW and/or HW configuration of the controller under test 150, e.g., which may be utilized for controlling the sensors, substantially untouched, e.g., as described below.

In some demonstrative aspects, simulator 102 may be configured to perform one or more operations and/or functionalities of a simulation (testing) mechanism, which may be configured according to a simulation setup, e.g., as described below.

In some demonstrative aspects, the controller under test 150 may be connected to the simulation setup, and may be running, for example, without being able to distinguish between the tester 102 and actual sensors, e.g., as connected when the controller under test 150 is actually deployed in the vehicle.

In some demonstrative aspects, as shown in FIG. 1, simulator 102 may be configured according to a simulation setup including a sensor simulator 111, e.g., as described below. Simulator 102 may include additional components, units, and/or entities, which are not shown in FIG. 1.

In some demonstrative aspects, sensor simulator 111 may be configured to receive environment information (“scene information”) 130, for example, a 3 Dimensional (3D) description or a 4 Dimensional (4D) description (scene) of the environment (“world”), which may be provided, for example, by a suitable modeling component 119 (also referred to as “scene simulator” or “environment (world) modeling component”). For example, the scene simulator 119 may provide the scene information 130 to the sensor simulator 111, for example based on one or more control commands, e.g., vehicle control commands, which be provided from the controller under test 150.

In some demonstrative aspects, one or more, e.g., some or all, components and/or functionalities of scene simulator 119 may be implemented as part of simulator 102.

In other aspects, one or more, e.g., some or all, components and/or functionalities of scene simulator 119 may be implemented separately from simulator 102, e.g., by an external modeling device and/or unit.

In some demonstrative aspects, sensor simulator 111 may include a radar simulator 110, which may be configured to provide simulated radar information based on the scene information 130, e.g., as described below.

In some demonstrative aspects, sensor simulator 111 may include one or more other sensor simulators (not shown in FIG. 1), which may be configured to provide simulated sensor information corresponding to one or more other types of sensors, for example, based on the scene information 130, e.g., as described below.

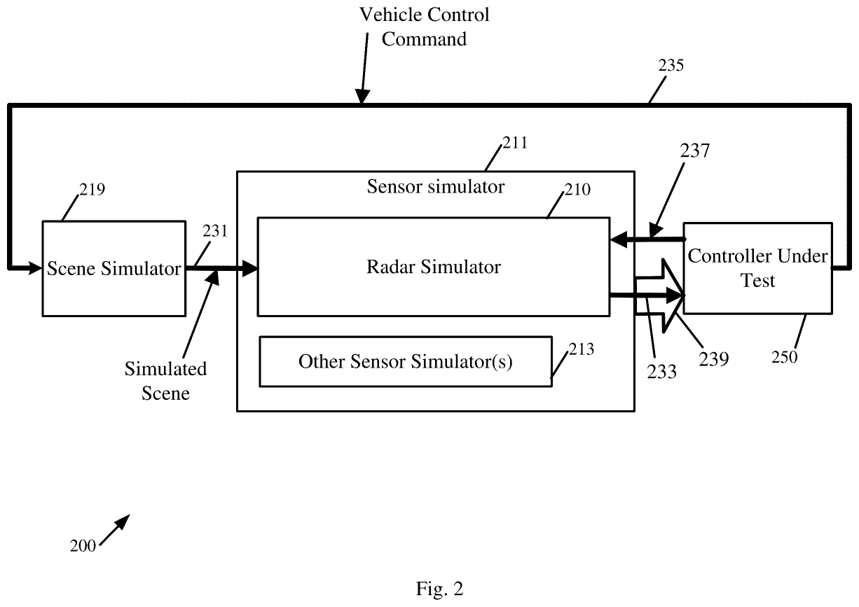

Reference is also made to FIG. 2, which schematically illustrates components and operations of a system 200 for simulation testing simulation testing, which may be implemented in accordance with some demonstrative aspects.

In some demonstrative aspects, a sensor simulator 211, e.g., sensor simulator 111 (FIG. 1), may be configured to render a scene, for example, according to one or more definitions of a sensor model to be simulated. For example, sensor simulator 211 may receive scene information 231 of a simulated scene from a scene simulator 219, e.g., scene simulator 119 (FIG. 1).

For example, sensor simulator 111 (FIG. 1) may include one or more components of sensor simulator 211, and/or sensor simulator 111 (FIG. 1) may be configured to perform one or more operations and/or functionalities of sensor simulator 211.

In some demonstrative aspects, sensor simulator 211 may be configured to send simulated sensor information 239, e.g., including simulated radar information 233, to a controller under test 250, e.g., controller under test 150 (FIG. 1).

In some demonstrative aspects, sensor simulator 211 may be configured to provide the simulated sensor information 239, e.g., including simulated radar information 233, to the controller under test 250, for example, such that the controller under test 250 may not be aware that the sensor simulator 211 is being used, e.g., instead of one or more real sensors.

In some demonstrative aspects, the controller under test 250 may receive and process the simulated sensor information 239 from the sensor simulator 211. For example, the controller under test 250 may generate one or more commands, e.g., based on analysis of the simulated sensor information 239, e.g., including simulated radar information 233, from the sensor simulator 211.

For example, the controller under test 250 may generate one or more vehicle control commands 235, e.g., based on analysis of the simulated sensor information 239 from the sensor simulator 211.

For example, the controller under test 250 may generate sensor control commands 237, e.g., including radar control commands, to control one or more sensors, e.g., including a radar, and may send the sensor control commands 237, which may be intended for receipt by the one or more sensors, e.g., form the point of view of the controller under test 250.

In some demonstrative aspects, the sensor simulator 211 may include, or may be configured to perform one or more functionalities and/or operations of, a radar simulator 210, which may be configured to generate simulated radar data 233 for the controller under test 250, e.g., as described below.

For example, radar simulator 110 (FIG. 1) may include one or more components of radar simulator 210, and/or radar simulator 110 (FIG. 1) may may be configured to perform one or more operations and/or functionalities of radar simulator 210.

In some demonstrative aspects, the sensor simulator 211 may include, or may be configured to perform one or more functionalities and/or operations of, one or more other sensor simulators 213. For example, the one or more sensor simulators 213 may include, for example, a Light Detection and Ranging (LiDAR) sensor, an image sensor, and/or any other suitable type of sensor.

In some demonstrative aspects, radar simulator 210 may be configured to process the simulated scene information 231 from the scene simulator 219. For example, the simulated scene information 231 may include information representing a simulated scene including, for example, one or more simulated objects (targets), e.g., cars, pedestrians, or the like, and/or a simulated environment, e.g., including a road surface, a guard rails, or the like.

In some demonstrative aspects, radar simulator 210 may be configured to generate the simulated radar data 233, for example, based on a given scene frame.

In some demonstrative aspects, the simulated radar data 233 may include, for example, a simulated radar point cloud, e.g., as described below.

In some demonstrative aspects, the simulated radar data 233 may include any other additional or alternative simulated processed radar data, which may be based, for example, on the simulated radar point cloud and/or any other processed radar information corresponding to the simulated radar system.

In some demonstrative aspects, the simulated radar data 233 may include, for example, any suitable additional or alternative higher layer processing, perception and/or fusion of a single frame Point Cloud.

In some demonstrative aspects, the simulated radar data 233 may include, for example, an object list, a tracked object list, bounding boxes, classification of objects, an accumulated Point cloud, a multi-frame filtered point cloud, drivable space information, or the like.

In some demonstrative aspects, the simulated radar data 233, e.g., including the simulated radar point cloud, may be configured according to one or more requirements of a radar point cloud input for the controller under test 250. For example, the simulated radar point cloud may be configured according to one or more requirements of a radar point cloud input for one or more higher level algorithms, for example, perception and/or driving decision algorithms, which may be implemented by the controller under test 250.

In some demonstrative aspects, in some use cases, and/or scenarios, there may be one or more technical aspects, which may be addressed, when implementing a radar simulation, which is based on a full radar simulation and processing of a scene.

For example, a full radar simulation may be configured to include a precise simulation of the time and space domain signals for given scene frame, and real-time radar processing of the frame. This full radar processing may require a large amount of computational resources, which may require the use of a dedicated radar chip to be connected to the scene simulator. However, such an implementation of a full radar simulation may require a high speed interface to be implemented in hardware and/or software, e.g., FPGAs and/or DSPs. Accordingly, this full radar simulation implementation may be complex, and/or may require significant effort and/or cost.

For example, a relatively long time may be required to generate the simulated radar data according to a full radar simulation, for example, when using a SW implementation of the full operations of the precise simulation of the time and space domain signals for given scene frame, and the real-time radar processing of the frame may take a long time, e.g., in case dedicated high-speed HW is not implemented.

Referring back to FIG. 1, in some demonstrative aspects, radar simulator 110 may implement a radar simulation technique (also referred to as “fast radar simulation”, or “simplified radar simulation”), which may be configured to generate output information (output) 133, which may include, or may be based on, simulated radar data, e.g., the simulated radar data 233 (FIG. 2), for example, with a latency, which may meet a latency requirement from a real radar system, which may be simulated by the radar simulator 110, e.g., as described below.

In some demonstrative aspects, radar simulator 110 may be configured to generate output information 133, which may include, or may be based on, the simulated radar data, e.g., the simulated radar data 233 (FIG. 2), for example, with a latency, which may not exceed the latency requirement from the real radar system, e.g., as described below.

In some demonstrative aspects, radar simulator 110 may be configured to generate output information 133, which may include, or may be based on, the simulated radar data, e.g., the simulated radar data 233 (FIG. 2), for example, with a latency, which may be lower than, e.g., even substantially lower than, the real time latency of the real radar system. For example, the latency of the radar simulator 110 may improve over time, e.g., according to a learning curve.

In some demonstrative aspects, radar simulator 110 may be configured to generate output information 133, which may include, or may be based on, the simulated radar data, e.g., the simulated radar data 233 (FIG. 2), for example, with a latency, which may be substantially equal to, or less than, the real latency of the real radar system, which may be simulated by the radar simulator 110, e.g., as described below.

In some demonstrative aspects, radar simulator 110 may be configured to provide the output information 133, which may include, or may be based on, the simulated radar data, e.g., the simulated radar data 233 (FIG. 2), as a simulated real-time radar output, e.g., to simulate a substantially real-time output of a radar system, e.g., according to one or more real-time radar system latency constraints, e.g., which may be defined by and/or expected by the controller under test 150, for example, as part of SIL and/or HIL testing, e.g., as described below.

In some demonstrative aspects, radar simulator 110 may be configured to generate output information 133, which may include, or may be based on, the simulated radar data, e.g., the simulated radar data 233 (FIG. 2), with a latency, which may meet the latency constraint of the real radar system, for example, to provide a technical solution to support operation of the simulator 102, for example, while the controller under test 150 is operating at a production mode.

In some demonstrative aspects, radar simulator 110 may be configured to generate output information 133, which may include, or may be based on, the simulated radar data, e.g., the simulated radar data 233 (FIG. 2), with a latency, which may meet the latency constraint of the real radar system, for example, to provide a technical solution to obviate a need for a special SIL or HIL mode.

In some demonstrative aspects, radar simulator 110 may be implemented as part of a simulator, e.g., simulator 102, which may be configured for simulation testing, for example, SIL testing and/or HIL testing, e.g., as described below.

In other aspects, radar simulator 110 may be implemented as part of any other suitable device and/or system, which may be configured to perform any other additional or alternative type of processing based on the simulated radar data. For example, radar simulator 110 may be implemented as part of any other suitable device and/or system, which may be utilize the simulated radar data for Artificial Intelligence (AI) training of one or more algorithms, e.g., perception algorithms, driving decision algorithms, or the like.

In some demonstrative aspects, radar simulator 110 may be configured to implement the fast radar simulation, for example, to generate output information 133, which may include, or may be based on simulated radar point cloud information, for example, with a latency, which may not exceed the latency requirement from the real radar system, e.g., as described below.

In some demonstrative aspects, radar simulator 110 may be configured to process the simulated scene information 130 from the scene simulator 119, for example, to identify a map of reflectors (“reflectors map”) in the scene, e.g., as described below.

In some demonstrative aspects, the reflectors map may include, for example, a five-dimensional (5D) reflections list or map, e.g., as described below.

In some demonstrative aspects, the 5D reflections list may include, for example, four dimensional (4D) spectrum information, e.g., including a range dimension, a Doppler dimension, an azimuth dimension, and an elevation dimension, e.g., as described below.

In some demonstrative aspects, the 5D reflections list may include, for example, the four dimensional (4D) spectrum information and a Radar cross-section (RCS) dimension, e.g., as described below. This type of 5D reflections list is also referred to as “a 4D+RCS map”.

In some demonstrative aspects, the 5D reflections list may be provided, in part or in whole, by the scene simulator 119, for example, as part of the simulated scene information 130, e.g., as described below.

In some demonstrative aspects, at least part of the 5D reflections list may be determined by the radar simulator 110, for example, based on the simulated scene information 130 from the scene simulator 119, e.g., as described below.

In some demonstrative aspects, radar simulator 110 may be configured to simulate a radar output spectrum, for example, based on the reflectors map and a Point Spread Function (PSF), which may be based on, may represent, and/or characterize, one or more, e.g., some or all, attributes of the simulated radar system, e.g., as described below.

In some demonstrative aspects, radar simulator 110 may be configured to simulate the radar output spectrum, for example, based on a multi-dimensional convolution, for example, between the reflectors map, e.g., the 5D reflections list, and the point spread function, e.g., as described below.

In other aspects, radar simulator 110 may be configured to simulate the radar output spectrum based on any other additional or alternative operations and/or functions applied to the reflectors map and/or the point spread function.

In some demonstrative aspects, radar simulator 110 may be configured to generate an adjusted simulated radar spectrum, for example, by applying to the radar output spectrum one or more adjustments, e.g., as described below.

In some demonstrative aspects, the one or more adjustments may be configured, for example, to represent one or more impairments, e.g., noise, Transmit (Tx)/Receive (Rx) impairments, and/or any other suitable adjustment, e.g., as described below.

In some demonstrative aspects, radar simulator 110 may be configured to generate the simulated radar point cloud information, for example, by applying one or more detection operations and/or techniques, to the simulated radar spectrum, e.g., as described below.

In some demonstrative aspects, radar simulator 110 may be configured to generate the simulated radar point cloud information, for example, to represent one or more key radar characteristics of the simulated radar system, e.g., Signal to Noise Ratio (SNR), resolutions, dynamic range, or the like, e.g., as described below.

In some demonstrative aspects, radar simulator 110 may be configured to generate the simulated radar point cloud information, for example, based on input configuration information 138 to define a configuration of the simulated radar system and/or a configuration of a radar environment, e.g., as described below.

For example, the input configuration information 138 may include PSF information to define one or more PSFs of the simulated radar system, for example, for range, Doppler, azimuth, and/or elevation dimensions, e.g., as described below.

For example, the input configuration information 138 may include radar setting information representing one or more settings of the simulated radar system, which may be used to derive the PSF information, e.g., as described below.

For example, the input configuration information 138 may include grid information on grids used in one or more, e.g., some or all, domains, e.g., as described below.

For example, the input configuration information 138 may include detector information indicating one or more detector parameters implemented by the simulated radar system, e.g., one or more SNR thresholds, or the like, e.g., as described below.

For example, the input configuration information 138 may include impairment information indicating one or more impairments of the simulated radar system. For example, the impairment information may include a Tx/Rx impairment, e.g., phase noise, Tx/Rx leakage, or the like, e.g., as described below.

In some demonstrative aspects, radar simulator 110 may be configured to implement the fast radar simulation, for example, to generate the simulated radar point cloud information, to provide a technical solution for avoiding a full time/space domain radar signal simulation, e.g., as described below.

In some demonstrative aspects, radar simulator 110 may be configured to implement the fast radar simulation, for example, to provide a technical solution to generate the simulated radar point cloud information, for example, in real time, e.g., while using GPU accelerators, or the like.

In some demonstrative aspects, radar simulator 110 may be configured to implement the fast radar simulation, for example, to provide a technical solution to generate the simulated radar point cloud information, for example, with reduced cost and/or reduced complexity, e.g., as described below.

In some demonstrative aspects, radar simulator 110 may be configured to implement the fast radar simulation, for example, to provide a technical solution to generate the simulated radar point cloud information, which may be suitable, for example, for massive data generation for massive MIMO radar validation in the closed loop.

In some demonstrative aspects, radar simulator 110 may be configured to implement the fast radar simulation, for example, to provide a technical solution to generate the simulated radar point cloud information, which may be suitable, for example, for SIL and/or HIL testing and/or validation of one or more algorithms, e.g., perception and driving algorithms, which may be implemented by the controller under test 150.

In some demonstrative aspects, radar simulator 110 may be configured to implement the fast radar simulation, for example, to provide a technical solution to generate the simulated radar point cloud information, which may be suitable, for example, for massive data generation for AI training of one or more algorithms, e.g., perception and driving algorithms.

In some demonstrative aspects, radar simulator 110 may be configured to determine simulated radar information 139 corresponding to a simulated scene for a simulated radar system, for example, by processing simulated scene information 131 corresponding to the simulated scene, e.g., as described below.

In some demonstrative aspects, radar simulator 110 may be configured to receive the simulated scene information 131 from the scene simulator 119, for example, as part of the scene information 130, e.g., as described below.

In other aspects, radar simulator 110 may be configured to determine at least part of the simulated scene information 131, for example, based on any suitable input information corresponding to the simulated scene, and/or radar simulator 110 may be configured to receive at least part of the simulated scene information 131 from one or more other elements of simulator 102.

In some demonstrative aspects, radar simulator 110 may include an input (IN) 135, which may be configured to receive the simulated scene information 131, the input configuration information 138, and/or any other input information, e.g., as described below.

In some demonstrative aspects, input 135 may include any suitable input interface, input unit, input module, input component, input circuitry, memory interface, memory access unit, memory reader, digital memory unit, bus interface, processor interface, or the like, which may be capable of receiving the simulated scene information 131, the input configuration information 138, and/or any other input information from a memory, a processor, and/or any other suitable component.

In some demonstrative aspects, radar simulator 110 may be configured to determine the simulated radar information 139 corresponding to the simulated scene, for example, for a simulated Multiple-Input-Multiple-Output (MIMO) radar system including a plurality of transmit antennas and a plurality of receive antennas, e.g., as described below.

In other aspects, radar simulator 110 may be configured to determine the simulated radar information 139 corresponding to the simulated scene, for example, for any other additional or alternative type of simulated radar system.

In some demonstrative aspects, radar simulator 110 may be configured to determine the simulated radar information 139 corresponding to the simulated scene, for example, by processing simulated scene information 131 corresponding to the simulated scene, for example, based on a path loss model and one or more Point Spread Functions (PSFs), e.g., as described below.

In some demonstrative aspects, the path loss model may represent a path loss of radar signals transmitted by one or more transmitters of the simulated radar system and received by one or more receivers of the simulated radar system, e.g., as described below.

In one example, the path loss model may include a mathematical representation, which may describe a change, e.g., a decrease, in signal strength and/or other signal properties, of the radar signals, e.g., between one or more transmitters of the simulated radar system and the one or more receivers of the simulated radar system.

In one example, the path loss model may be based on one or more properties of the simulated scene, for example, the location, orientation and/or other properties of one or more objects in the simulated scene, an environment in the simulated scene, and the like.

In one example, the path loss model may be based on one or more properties of the radar signals communicated by the simulated radar system, e.g., Tx strength, frequency, and the like.

In some demonstrative aspects, the one or more PSFs may correspond to one or more radar processing procedures applied by the simulated radar system, e.g., as described below.

In some demonstrative aspects, radar simulator 110 may be configured to provide output information (output) 133 based on the simulated radar information 139, e.g., as described below.

In some demonstrative aspects, the output information 133 may include at least part of, e.g., some or all of, the simulated radar information 139, e.g., as described below.

In some demonstrative aspects, the output information 133 may be based on any suitable processing of at least part of, e.g., some or all of, the simulated radar information 139, e.g., as described below.

In some demonstrative aspects, radar simulator 110 may include an output (OUT) 137, which may be configured to provide the output information 133, e.g., as described below.

In some demonstrative aspects, output 137 may include any suitable output interface, output unit, output module, output component, output circuitry, memory interface, memory access unit, memory writer, digital memory unit, bus interface, processor interface, or the like, which may be capable of outputting the output information 133 to a memory, a processor, and/or any other suitable component to handle the output information 133.

In some demonstrative aspects, radar simulator 110 may be configured to determine the simulated radar information 139 corresponding to the simulated scene, for example, by processing simulated scene information 131 corresponding to the simulated scene, for example, based on the one or more PSFs, which may include a PSF based on a range processing procedure of the simulated radar system, e.g., as described below.

In some demonstrative aspects, radar simulator 110 may be configured to determine the simulated radar information 139 corresponding to the simulated scene, for example, by processing simulated scene information 131 corresponding to the simulated scene, for example, based on the one or more PSFs, which may include a PSF based on a Doppler processing procedure of the simulated radar system, e.g., as described below.

In some demonstrative aspects, radar simulator 110 may be configured to determine the simulated radar information 139 corresponding to the simulated scene, for example, by processing simulated scene information 131 corresponding to the simulated scene, for example, based on the one or more PSFs, which may include a PSF based on an azimuth processing procedure of the simulated radar system, e.g., as described below.

In some demonstrative aspects, radar simulator 110 may be configured to determine the simulated radar information 139 corresponding to the simulated scene, for example, by processing simulated scene information 131 corresponding to the simulated scene, for example, based on the one or more PSFs, which may include a PSF based on an elevation processing procedure of the simulated radar system, e.g., as described below.

In other aspect, the one or more PDFs utilized by the radar simulator 110 may include any other suitable additional or alternative PSF, for example, corresponding to any other additional or alternative processing procedure of the simulated radar system.

In some demonstrative aspects, radar simulator 110 may be configured to determine the simulated radar information 139 corresponding to the simulated scene, for example, by processing simulated scene information 131, which may include, for example, a five-dimensional (5D) energy map, e.g., as described below.

In some demonstrative aspects, the 5D energy map may include, for example, a range dimension, a Doppler dimension, an azimuth dimension, an elevation dimension, and a Radar Cross-Section (RCS) dimension, e.g., as described below.

In other aspects, the simulated scene information 131 may include any other additional or alternative type and/or format of simulated scene information.

In some demonstrative aspects, radar simulator 110 may be configured to determine the simulated radar information 139 to include, for example, simulated radar point cloud information corresponding to the simulated scene, e.g., as described below.

In some demonstrative aspects, radar simulator 110 may be configured to determine the simulated radar information 139 to include, for example, an object list.

In some demonstrative aspects, radar simulator 110 may be configured to determine the simulated radar information 139 to include, for example, a tracked object list.

In some demonstrative aspects, radar simulator 110 may be configured to determine the simulated radar information 139 to include, for example, bounding box information of one or more bounding boxes.

In some demonstrative aspects, radar simulator 110 may be configured to determine the simulated radar information 139 to include, for example, classification information to classify one or more objects.

In some demonstrative aspects, radar simulator 110 may be configured to determine the simulated radar information 139 to include, for example, an accumulated point cloud.

In some demonstrative aspects, radar simulator 110 may be configured to determine the simulated radar information 139 to include, for example, a multi-frame filtered point cloud.

In some demonstrative aspects, radar simulator 110 may be configured to determine the simulated radar information 139 to include, for example, drivable space information.

In some demonstrative aspects, radar simulator 110 may be configured to determine the simulated radar information 139 to include any other additional or alternative type of information.

In some demonstrative aspects, radar simulator 110 may be configured to provide the output information 133, which may include, and/or may be based on, the simulated radar point cloud information, the object list, the tracked object list, the bounding box information, the classification information, the accumulated point cloud, the multi-frame filtered point cloud, the drivable space information, and/or any other suitable type of information.

In some demonstrative aspects, radar simulator 110 may be configured to provide the output information 133 including, for example, simulated radar data to be provided by a SIL simulator to the controller under test 150, e.g., as described above.

In some demonstrative aspects, radar simulator 110 may be configured to provide the output information 133 including, for example, simulated radar data to be provided by an HIL simulator to the controller under test 150, e.g., as described above.

In some demonstrative aspects, radar simulator 110 may be configured to provide the output information 133 including, for example, simulated radar data, which may be configured, for example, to train an Artificial Intelligence (AI) based algorithm, e.g., as described above.

In some demonstrative aspects, radar simulator 110 may be configured to provide the output information 133, which may be configured, for example, in compliance with one or more real-time radar system latency constraints for the simulated radar system, e.g., as described above.

In some demonstrative aspects, radar simulator 110 may be configured to configure the one path loss model and/or the one or more PSFs to be used in determining the simulated radar information 139, for example, based on simulation setting information to define one or more settings of the simulated radar system, e.g., as described below.

In some demonstrative aspects, radar simulator 110 may be configured to receive at least part of, e.g., some or all of, the simulation setting information, for example, as part of input configuration information 138, e.g., as described below.

In some demonstrative aspects, at least part of, e.g., some or all of, the simulation setting information may be preconfigured at radar simulator 110, for example, based on one or more preconfigured settings of the simulated radar system, e.g., as described below.

In some demonstrative aspects, radar simulator 110 may be configured to configure the path loss model to be used in determining the simulated radar information 139, for example, based on one or more parameters and/or criteria, e.g., as described below.

In some demonstrative aspects, radar simulator 110 may be configured to configure the path loss model, for example, based on one or more radar communication settings to configure communication of the radar signals by the simulated radar system, e.g., as described below.

In some demonstrative aspects, the one or more radar communication settings may include, for example, a Tx power to transmit the radar signals by the simulated radar system, e.g., as described below.

In some demonstrative aspects, the one or more radar communication settings may include, for example, a Tx antenna pattern of the simulated radar system, e.g., as described below.

In some demonstrative aspects, the one or more radar communication settings may include, for example, an Rx antenna pattern of the simulated radar system, e.g., as described below.

In some demonstrative aspects, the one or more radar communication settings may include, for example, a radar frame structure for transmission of the radar signals by the simulated radar system, e.g., as described below.

In some demonstrative aspects, the one or more radar communication settings may include, for example, a Tx method for transmission of the radar signals by the simulated radar system, e.g., as described below.

In other aspects, the one or more radar communication settings may include any other additional or alternative settings configure communication of the radar signals by the simulated radar system.

In some demonstrative aspects, radar simulator 110 may be configured to receive radar communication setting information to define at least part of, e.g., some or all of, the radar communication settings, for example, as part of input configuration information 138, e.g., as described below.

In some demonstrative aspects, at least part of, e.g., some or all of, the radar communication settings may be preconfigured at radar simulator 110, for example, based on one or more preconfigured communication settings of the simulated radar system, e.g., as described below.

In some demonstrative aspects, radar simulator 110 may be configured to configure the path loss model, for example, based on installation information defining an installation of one or more antennas of the simulated radar system, e.g., as described below.

In some demonstrative aspects, radar simulator 110 may be configured to configure the path loss model, for example, based on installation information defining an installation location of one or more antennas of the simulated radar system, e.g., as described below.

In some demonstrative aspects, radar simulator 110 may be configured to configure the path loss model, for example, based on installation information defining an installation orientation of one or more antennas of the simulated radar system, e.g., as described below.

In some demonstrative aspects, radar simulator 110 may be configured to receive at least part of, e.g., some or all of, the installation information, for example, as part of input configuration information 138, e.g., as described below.

In some demonstrative aspects, at least part of, e.g., some or all of, the installation information may be preconfigured at radar simulator 110, for example, based on one or more preconfigured installation settings of the simulated radar system, e.g., as described below.

In some demonstrative aspects, radar simulator 110 may be configured to configure the path loss model, for example, based on one or more interference conditions for the simulated scene, e.g., as described below.

In some demonstrative aspects, radar simulator 110 may be configured to configure the path loss model, for example, based on one or more weather conditions for the simulated scene, e.g., as described below.

In other aspects, radar simulator 110 may be configured to configure the path loss model based on any other additional or alternative information.

In some demonstrative aspects, radar simulator 110 may be configured to receive information defining at least part of, e.g., some or all of, the one or more interference conditions, the one or more weather conditions, and/or any other conditions, for example, as part of input configuration information 138, e.g., as described below.

In some demonstrative aspects, at least part of, e.g., some or all of, the one or more interference conditions, the one or more weather conditions, and/or any other conditions may be preconfigured at radar simulator 110, for example, based on one or more preconfigured settings of the simulated radar system, e.g., as described below.

In some demonstrative aspects, radar simulator 110 may be configured to configure the one or more PSFs to be used in determining the simulated radar information, for example, based on one or more parameters and/or criteria, e.g., as described below.

In some demonstrative aspects, radar simulator 110 may be configured to configure the one or more PSFs, for example, based on one or more settings of the simulated radar system, e.g., as described below.

In some demonstrative aspects, radar simulator 110 may be configured to configure the one or more PSFs, for example, based on a processing window setting of the simulated radar system, e.g., as described below.

In some demonstrative aspects, radar simulator 110 may be configured to configure the one or more PSFs, for example, based on a signal bandwidth setting of the simulated radar system, e.g., as described below.

In some demonstrative aspects, radar simulator 110 may be configured to configure the one or more PSFs, for example, based on a Pulse Repetition Interval (PRI) setting of the simulated radar system, e.g., as described below.

In some demonstrative aspects, radar simulator 110 may be configured to configure the one or more PSFs, for example, based on a number-of-pulses-per-frame setting of the simulated radar system, e.g., as described below.

In some demonstrative aspects, radar simulator 110 may be configured to configure the one or more PSFs, for example, based on a frame length setting of the simulated radar system, e.g., as described below.

In some demonstrative aspects, radar simulator 110 may be configured to configure the one or more PSFs, for example, based on an array aperture setting of the simulated radar system, e.g., as described below.

In other aspects, radar simulator 110 may be configured to configure the one or more PSFs based on any other additional or alternative information.

In some demonstrative aspects, radar simulator 110 may be configured to receive radar setting information defining at least part of, e.g., some or all of, the one or more settings of the simulated radar system, for example, as part of input configuration information 138, e.g., as described below.

In some demonstrative aspects, at least part of, e.g., some or all of, the one or more settings of the simulated radar system may be preconfigured at radar simulator 110, for example, based on one or more preconfigured settings of the simulated radar system, e.g., as described below.

In some demonstrative aspects, radar simulator 110 may be configured to configure the one path loss model and/or the one or more PSFs to be used in determining the simulated radar information 139, for example, based on preconfigured simulation setting information, which may define one or more preconfigured settings of the simulated radar system.

In some demonstrative aspects, the preconfigured simulation setting information may include at least part of, e.g., some or all of, the types of simulation setting information described above.

In some demonstrative aspects, radar simulator 110 may be configured to configure the one path loss model and/or the one or more PSFs to be used in determining the simulated radar information 139, for example, based on user-provided simulation setting information, which may be provided by a user, e.g., as described below.

In some demonstrative aspects, the user-provided simulation setting information may include at least part of, e.g., some or all of, the types of simulation setting information described above.

In some demonstrative aspects, radar simulator 110 may be configured to provide a user interface (UI) 181, which may be configured to receive simulation setting information 132 from a user, e.g., as described below.

In some demonstrative aspects, the simulation setting information 132 received via the UI 181 may include information to define one or more settings of the simulated radar system.

For example, the simulation setting information 132 received via the UI 181 may include information to define one or more of, e.g., some or all of, the settings of the simulated radar system described above, and/or any other additional or alterative settings.

In some demonstrative aspects, radar simulator 110 may be configured to determine the simulated radar information, for example, based on the simulation setting information 132 received via the UI 181.

In some demonstrative aspects, radar simulator 110 may be configured to configure at least one PSF to be used in determining the simulated radar information, for example, based on the simulation setting information 132 received via the UI 181.

In some demonstrative aspects, radar simulator 110 may be configured to configure the path loss model to be used in determining the simulated radar information, for example, based on the simulation setting information 132 received via the UI 181.

In some demonstrative aspects, radar simulator 110 may be configured to determine a multi-dimensional energy map, for example, by processing the simulated scene information 131 based on the path loss model, e.g., as described below.

In some demonstrative aspects, radar simulator 110 may be configured to determine the simulated radar information 139, for example, by processing the multi-dimensional energy map based on the one or more PSFs, e.g., as described below.

In some demonstrative aspects, radar simulator 110 may be configured to determine the multi-dimensional energy map, for example, according to a ray-tracing mechanism, e.g., as described below.

In other aspects, radar simulator 110 may be configured to determine the multi-dimensional energy map based on any other additional or alternative mechanism and/or technique.

In some demonstrative aspects, radar simulator 110 may be configured to determine the multi-dimensional energy map to include, for example, a four-dimensional (4D) energy map, e.g., as described below.

In some demonstrative aspects, the 4D energy map may include, for example, a range dimension, a Doppler dimension, an azimuth dimension, and an elevation dimension, e.g., as described below.

In other aspects, the multi-dimensional energy map to include any other suitable type of multi-dimensional energy map.

In some demonstrative aspects, radar simulator 110 may be configured to determine the simulated radar information 139, for example, by applying one or more multi-dimensional convolutions to the multi-dimensional energy map, for example, based on the one or more PSFs, e.g., as described below.

In some demonstrative aspects, radar simulator 110 may be configured to configure the one or more multi-dimensional convolutions to include at least one sparse convolution, e.g., as described below.

In other aspect, any other additional or alternative multi-dimensional convolutions may be implemented.

In some demonstrative aspects, radar simulator 110 may be configured to determine a first convolution result, for example, based on a first multi-dimensional convolution of the multi-dimensional energy map with at least one first PSF, e.g., as described below.

In some demonstrative aspects, the at least one first PSF may be configured, for example, according to one or more first processing procedures of the simulated radar system, e.g., as described below.

In some demonstrative aspects, the at least one first PSF may be configured, for example, according to a range processing procedure of the simulated radar system, e.g., as described below.

In some demonstrative aspects, the at least one first PSF may be configured, for example, according to a Doppler processing procedure of the simulated radar system, e.g., as described below.

In other aspects, the at least one first PSF may be configured according to any other additional or alternative processing procedure of the simulated radar system.

In some demonstrative aspects, radar simulator 110 may be configured to determine the simulated radar information 139, for example, based on a second convolution result, e.g., as described below.

In some demonstrative aspects, the second convolution result may be based, for example, on a second multi-dimensional convolution of the first convolution result with at least one second PSF, e.g., as described below.

In some demonstrative aspects, the at least one second PSF may be configured, for example, according to one or more second processing procedures of the simulated radar system, e.g., as described below.

In some demonstrative aspects, the at least one second PSF may be configured, for example, according to an azimuth processing procedure of the simulated radar system, e.g., as described below.

In some demonstrative aspects, the at least one second PSF may be configured, for example, according to an elevation processing procedure of the simulated radar system, e.g., as described below.

In other aspects, the at least one second PSF may be configured according to any other additional or alternative processing procedure of the simulated radar system.

In some demonstrative aspects, radar simulator 110 may be configured to determine the simulated radar information 139, for example, by applying first and second multi-dimensional convolutions to the multi-dimensional energy map, e.g., as described below.

In other aspects, radar simulator 110 may be configured to determine the simulated radar information 139, for example, by any other suitable count of multi-dimensional convolutions to the multi-dimensional energy map.

In one example, radar simulator 110 may be configured to determine the simulated radar information 139, for example, by applying a single multi-dimensional convolution to the multi-dimensional energy map.

In one example, radar simulator 110 may be configured to determine the simulated radar information 139, for example, by applying three or more multi-dimensional convolutions to the multi-dimensional energy map.

In some demonstrative aspects, radar simulator 110 may be configured to determine a simulated radar spectrum, for example, by processing the multi-dimensional energy map based on the one or more PSFs, e.g., as described below.

In some demonstrative aspects, radar simulator 110 may be configured to determine an adjusted simulated radar spectrum, for example, by adjusting the simulated radar spectrum according to one or more adjustment models, e.g., as described below.

In some demonstrative aspects, radar simulator 110 may be configured to determine the simulated radar information 139, for example, based on the adjusted simulated radar spectrum, e.g., as described below.

In some demonstrative aspects, the one or more adjustment models may include a noise adjustment model, which may be configured, for example, to model noise affecting the simulated radar system, e.g., as described below.

In one example, the noise adjustment model may be configured, for example, to model the noise affecting the simulated radar system, for example, based on the simulated scene information 131, the input configuration information 138, and/or based on the simulation setting information 132.

In some demonstrative aspects, the one or more adjustment models may include a phase noise adjustment model, which may be configured, for example, to model phase noise affecting the simulated radar system, e.g., as described above.

In one example, the phase noise adjustment model may be configured, for example, to model the phase noise affecting the simulated radar system, for example, based on the simulated scene information 131, the input configuration information 138, and/or based on the simulation setting information 132.

In some demonstrative aspects, the one or more adjustment models may include a Transmit to Receive (Tx-RX) leakage adjustment model, which may be configured, for example, to model a Tx-Rx leakage of the simulated radar system, e.g., as described below.

In one example, the phase noise adjustment model may be configured, for example, to model the phase noise affecting the simulated radar system, for example, based on the input configuration information 138, and/or based on the simulation setting information 132.

In some demonstrative aspects, the one or more adjustment models may include an interference model, which may be configured, for example, to model interference affecting the simulated radar system, e.g., as described below.

In one example, the interference model may be configured, for example, to model the interference affecting the simulated radar system, for example, based on the simulated scene information 131, the input configuration information 138, and/or based on the simulation setting information 132.

In some demonstrative aspects, the one or more adjustment models may include a weather model, which may be configured, for example, to model one or more weather conditions affecting the simulated radar system, e.g., as described below.

In one example, the weather model may be configured, for example, to model the one or more weather conditions affecting the simulated radar system, for example, based on the simulated scene information 131, the input configuration information 138, and/or based on the simulation setting information 132.

In other aspects, the one or more adjustment models may include any other suitable additional or alternative model to adjust the simulated radar spectrum based on one or more additional or alternative types of conditions, parameters, and/or settings, which may affect the simulated radar system.

In some demonstrative aspects, radar simulator 110 may be configured to determine the simulated radar information 139, for example, by applying a detection mechanism to the adjusted simulated radar spectrum, e.g., as described below.

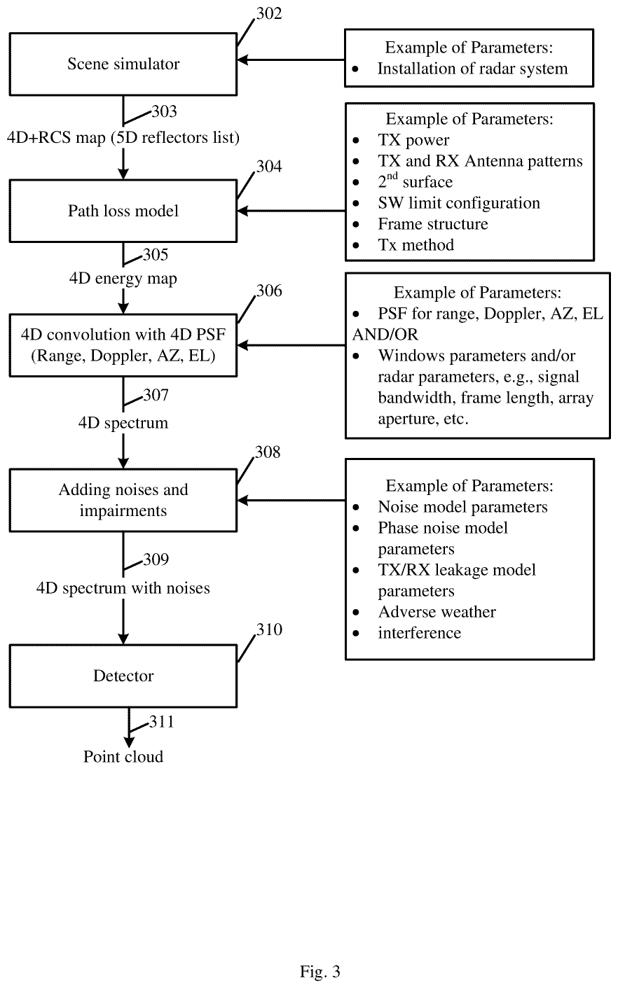

Reference is made to FIG. 3, which illustrates a method of generating simulated radar data of a simulated radar system, in accordance with some demonstrative aspects. For example, a radar simulator, e.g., radar simulator 110 (FIG. 1) and/or radar simulator 210 (FIG. 2), may be configured to perform one or more, e.g., some or all, operations of the method of FIG. 3, for example, to determine simulated radar data, e.g., simulated radar data 139 (FIG. 1).

In some demonstrative aspects, as indicated at block 302, the method may include processing simulated scene information 303 corresponding to a scene frame.

In some demonstrative aspects, the simulated scene information 303 may be provided by a scene simulator. For example, as shown in FIG. 3, the simulated scene information 303 may be determined, for example, based on one or more installation parameters corresponding to an installation of the simulated radar system. For example, the one or more installation parameters may include a radar unit location and/or a radar unit boresight orientation.

For example, the scene information 130 (FIG. 1) provided by the scene simulator 119 (FIG. 1) may include the simulated scene information 303.

In some demonstrative aspects, the simulated scene information 303 may include information of a modeled multi-dimensional spectrum.

In some demonstrative aspects, the simulated scene information 303 may include a 5D reflections list, e.g., in the form of a 4D+RCS map.

In some demonstrative aspects, the simulated scene information 303 may include information of, e.g., a list of, reflectors located in the 4D space. For example, a reflector, e.g., each reflector, may be characterized by an RCS.

In some demonstrative aspects, the 4D+RCS map may be provided, for example, by a suitable ray-tracing engine.

For example, the ray-tracing engine may be configured to provide information of one or more emulated objects in the simulated scene. For example, the information for an emulated object may include some or all of an Angle of Arrival (AoA) of one or more reflections from the object, e.g., an Azimuth (Az) AoA and/or an Elevation (El) AoA; an Angle of Departure (AoD), e.g., an Az AoD and/or an El AoD of one or more reflections from the object; a radial velocity of one or more reflections from the object; a distance of one or more reflections from the object; and a received power of one or more reflections from the object, e.g., a reflector RCS at a spatial viewing angle; and/or any other suitable additional or alternative information for the one or more reflections from the emulated object.

For example, scene simulator 119 (FIG. 1) may include a suitable ray-tracing engine, which may generate the 4D+RCS map (5D reflections list), for example, based on a scene defined by the controller under test 150 (FIG. 1). For example, scene simulator 119 (FIG. 1) may generate the simulated scene information 130 (FIG. 1) including the 5D reflections list.

For example, the 5D reflections list may include a plurality of entries corresponding to a plurality of point reflections.

In one example, an entry in the 5D reflections list may include the following information, e.g., for a single point reflection:

TABLE 1

| Range [m] | Doppler [m/s] | Az [deg] | El [deg] | RCS [dBsm] |
|---|---|---|---|---|
| 43.6543 | −13.587 | −35 | 7 | −5 |

In other aspects, an entry in the 5D reflections list may include any other additional or alternative information corresponding to the point reflection.

In some demonstrative aspects, as indicated at block 304, the method may include determining a multi-dimensional energy map 305, for example, by processing the simulated scene information 303 based on a path loss model, e.g., as described below.

In some demonstrative aspects, as indicated at block 304, determining the multi-dimensional energy map 305 may include determining the multi-dimensional energy map 305, e.g., a 4D energy map, for example, according to the path loss model, which may be applied to the 5D reflections list (4D+RCS map) 303.

For example, the reflected energy from the reflectors may be modeled and scaled, for example, according to free path loss equations of a suitable free path loss model, e.g., assuming that radar Transmit (Tx) power of the simulated radar system is known, e.g., as an input parameter of the system.

For example, an effect of Tx and/or Receive (Rx) antenna patterns of the simulated radar system may be modeled and taken into consideration as part of the free path loss model.

For example, the path loss model may be modeled according to one or more second surface parameters, which may define one or more 2^{nd} surface modifications applied to the Tx and/or Rx beam patterns of the simulated radar system.

For example, the path loss model may be modeled according to one or more parameters relating to a SW limit configuration of the simulated radar system, for example, an elevation angle range limit, an azimuth angle range limit, a distance limit, or the like.

For example, the path loss model may be modeled according to one or more parameters relating to a frame structure and/or a Tx method implemented by the simulated radar system.

In one example, the Tx power may have a different gain, e.g., due to constructive interference at the object within its Beamforming (BF) beam, for example, when Tx BF is used by the simulated radar system.

For example, the path loss model may be modeled according to one or more weather conditions, e.g., using a path loss model for rain, fog, snow, or the like.

In some demonstrative aspects, as indicated at block 306, the method may include determining a multi-dimensional radar spectrum 307, e.g., a 4D radar spectrum, for example, based on the multi-dimensional energy map 305, e.g., as described below.

In some demonstrative aspects, as indicated at block 306, the method may include determining the multi-dimensional radar spectrum 307, for example, by processing the multi-dimensional energy map 305 based on one or more PSFs corresponding to the simulated radar system, e.g., as described below.

In some demonstrative aspects, the one or more PSFs may be based on, may define, and/or may represent, one or more radar processing procedures applied by the simulated radar system.

In some demonstrative aspects, the one or more PSFs may be based on, may define, and/or may represent, one or more attributes and/or capabilities of the simulated radar system.

For example, the one or more PSFs may represent the resolution and/or dynamic range capabilities of the radar, and/or any other suitable attribute and/or capability of the radar system, which may affect the output radar data provided by the simulated radar system.

In some demonstrative aspects, the one or more PSFs may include, for example, a PSF corresponding to a range processing procedure applied by the simulated radar system.

In some demonstrative aspects, the one or more PSFs may include, for example, a PSF corresponding to a Doppler processing procedure applied by the simulated radar system.

In some demonstrative aspects, the one or more PSFs may include, for example, a PSF corresponding to an azimuth processing procedure applied by the simulated radar system.

In some demonstrative aspects, the one or more PSFs may include, for example, a PSF corresponding to an elevation processing procedure applied by the simulated radar system.

In other aspects, the one or more PSFs may include any other additional or alternative PSF corresponding to any other additional or alternative radar processing operations and/or procedures to be performed by the simulated radar system.

In some demonstrative aspects, as indicated at block 306, the method may include determining the multi-dimensional radar spectrum 307, for example, based on one or more multi-dimensional convolutions, e.g., a 4D convolution, of the multi-dimensional energy map 305 with the one or more PSFs, e.g., as described below.

In some demonstrative aspects, the method may include receiving one or more of the PSFs as an input by the radar simulator. For example, radar simulator 110 (FIG. 1) may be configured to receive an input including information, e.g., input information 138 (FIG. 1) and/or information 132 (FIG. 1), to define one or more of the PSFs of the simulated radar system, e.g., as described above.

In some demonstrative aspects, the method may include determining one or more of the PSFs by the radar simulator. For example, radar simulator 110 (FIG. 1) may be configured to determine one or more of the PSFs of the simulated radar system.

For example, the radar simulator, e.g., radar simulator 110 (FIG. 1), may be configured to derive a PSF, for example, from one or more radar parameters of the simulated radar system, e.g., processing window parameters, signal bandwidth, Pulse Repetition Interval (PRI), number of pulses, or the like.

In some demonstrative aspects, the method may include determining the multi-dimensional radar spectrum 307, for example, based on a sparse convolution, e.g., based on knowledge that the 4D energy reflections map 305 is sparse. For example, the sparse convolution may be implemented to provide a technical solution to reduce processing time and/or complexity.

In some demonstrative aspects, as indicated at block 306, applying the one or more multi-dimensional convolutions to the multi-dimensional energy map 305 may include determining a first convolution result, for example, based on a first multi-dimensional convolution of the multi-dimensional energy map 305 with at least one first PSF, e.g., as described below.

In some demonstrative aspects, the at least one first PSF may be configured, for example, according to one or more first processing procedures of the simulated radar system.

In some demonstrative aspects, the at least one first PSF may be configured, for example, according to a range processing procedure of the simulated radar system and/or a Doppler processing procedure of the simulated radar system.

In some demonstrative aspects, as indicated at block 306, applying the one or more multi-dimensional convolutions to the multi-dimensional energy map 305 may include determining the multi-dimensional radar spectrum 307 based on a second convolution result, which may be based, for example, on a second multi-dimensional convolution of the first convolution result with at least one second PSF.

In some demonstrative aspects, the at least one second PSF may be configured, for example, according to one or more second processing procedures of the simulated radar system.

In some demonstrative aspects, the at least one second PSF may be configured, for example, according to an azimuth processing procedure of the simulated radar system and/or an elevation processing procedure of the simulated radar system.

In some demonstrative aspects, as indicated at block 308, the method may include determine an adjusted simulated radar spectrum 309, for example, by adjusting the simulated radar spectrum 307 according to one or more adjustment models.

For example, as indicated at block 308, the method may include determining the adjusted multi-dimensional radar spectrum 309, e.g., an adjusted 4D radar spectrum, for example, by adjusting the multi-dimensional radar spectrum 307 according to one or more impairments.

In some demonstrative aspects, the one or more adjustment models may include a noise adjustment model configured to model noise affecting the simulated radar system.

In some demonstrative aspects, the one or more adjustment models may include a phase noise adjustment model configured to model phase noise affecting the simulated radar system.

In some demonstrative aspects, the one or more adjustment models may include a Tx-RX leakage adjustment model configured to model a Tx-Rx leakage of the simulated radar system.

For example, noise and/or Tx/Rx impairments, e.g. leakage, may be added to the generated 4D radar spectrum 307 to provide the adjusted simulated radar spectrum 309.

In some demonstrative aspects, the one or more adjustment models may include a weather model configured to model one or more weather conditions affecting the simulated radar system.

For example, the one or more impairments applied to the generated 4D radar spectrum 307 may be modeled, for example, according to one or more adverse weather condition models, e.g., a model for rain, fog, snow or the like.

In some demonstrative aspects, the one or more adjustment models may include an interference model configured to model interference affecting the simulated radar system.

For example, e one or more impairments applied to the generated 4D radar spectrum 307 may be modeled, for example, according to one or more interference models.

For example, the obtained adjusted 4D radar spectrum 309 may be configured to be substantially similar to a simulated radar spectrum, e.g., generated using a full time/space domain processing.

In some demonstrative aspects, as indicated at block 310, the method may include generating a simulated radar point cloud 311, for example, based on the simulated multi-dimensional radar spectrum 307, e.g., based on the adjusted multi-dimensional radar spectrum 309.

For example, the 4D spectrum 307, e.g., the adjusted 4D spectrum 309, may be processed, e.g., by a suitable detector, for example, to simulate a detector used by the simulated radar system, e.g., with low computational effort, for example, to generate the simulated radar point cloud 311.

In some demonstrative aspects, the simulated radar point cloud 311 provided by the radar simulator, e.g., according to the fast radar simulation technique described above, may be compared, for example, with a reference point cloud, for example, to asses a quality of the simulated radar point cloud, and/or to improve a quality of the simulated radar point cloud. In one example, the reference point cloud may include a point cloud determined according to a full radar signal-level simulation.

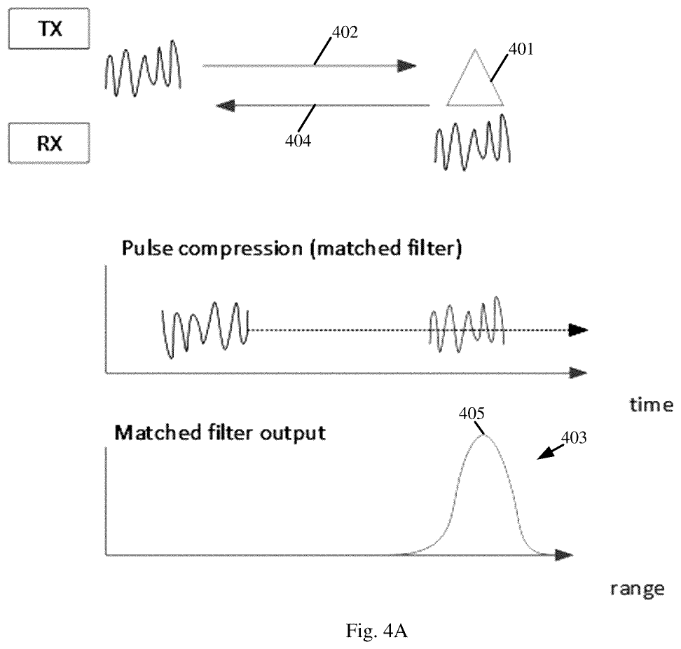

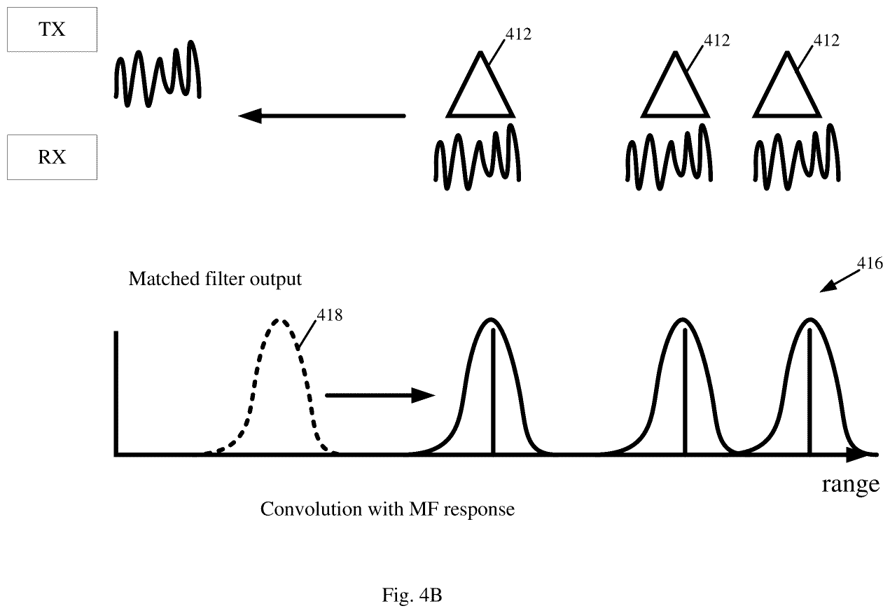

Reference is made to FIGS. 4A and 4B, which schematically illustrate a radar simulation technique to simulate radar data to be provided by a simulated radar system, in accordance with some demonstrative aspects.

For example, the radar simulation technique of FIGS. 4A and 4B may be implemented to simulate a range of an object to be provided by the simulated radar system.

For example, a similar radar simulation technique may be implemented to simulate a Doppler of the object, an azimuth of the object, and/or an elevation of the object to be provided by the simulated radar system.

For example, as shown in FIG. 4A, a radar system may transmit a radar Tx signal pulse 402, which may be reflected from a target 401, and received by the radar system as a radar Rx signal 404.

For example, as shown in FIG. 4A, the radar system may process the radar Rx signal 404, for example, by Matched Filtering (MF) and/or any other suitable radar processing technique, to provide a radar spectrum 403.

For example, as shown in FIG. 4A, detections of targets may be determined based on one or more peaks 405 of the radar spectrum 403.

For example, as shown in FIG. 4B, the radar spectrum 405 may be simulated, for example, even without a full simulation of the radar propagation path of the radar Tx signal 402 and the radar Rx signal 404.

For example, as shown in FIG. 4B, a simulated radar spectrum 416 to simulate a radar spectrum, e.g., similar to the radar spectrum 403 may be determined, for example, based on knowledge of the target locations of targets 412 in a simulated scenario. For example, the target locations may be identified based on the simulated scene input received by radar simulator 110 (FIG. 1), e.g., as described above.

For example, the MF output may be modeled, for example, by a PSF 418, e.g., representing an MF response, which may be based on the setting of the simulated radar system.

For example, as shown in FIG. 4B, the simulated radar spectrum 416 may be determined based on a convolution of the known target locations of targets 412 with the PSF 418.

For example, the simulated radar spectrum 416 may be determined, e.g., even without any time simulation.

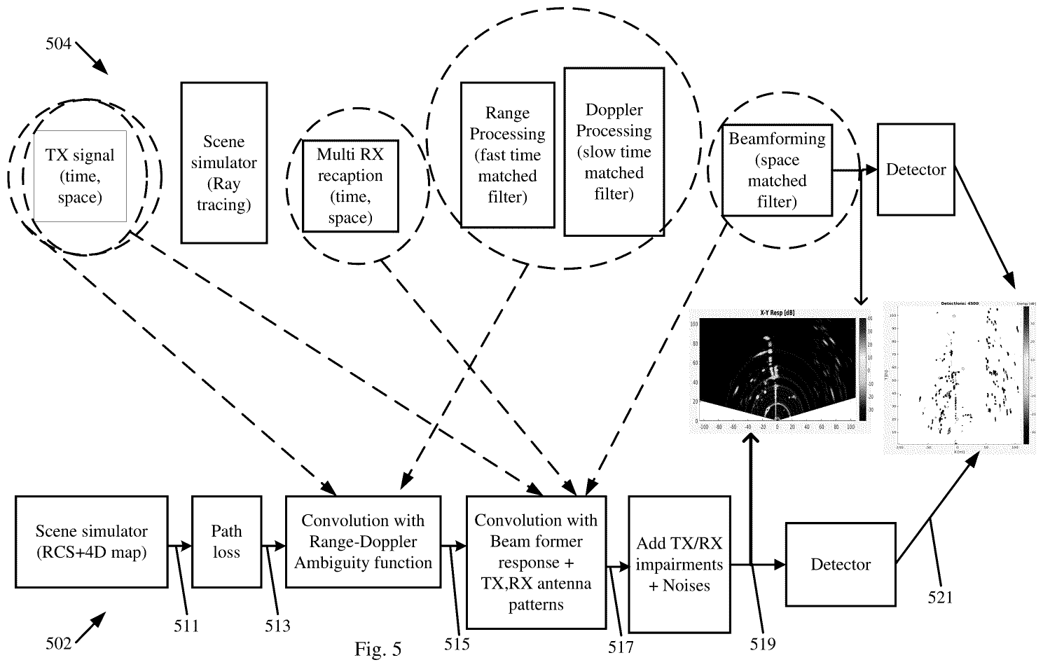

Reference is made to FIG. 5, which schematically illustrates a radar simulation path 502 compared to a full radar signal-level simulation path 504, in accordance with some demonstrative aspects.

For example, radar simulator 110 (FIG. 1) may be configured to implement one or more operations according to the radar simulation path 502.

For example, the radar simulation path 502 may be implemented according to one or more, e.g., some or all, of the operations of the method of FIG. 3.

For example, as shown in FIG. 5, the radar simulation path 502 may include simulation of a radar scene 511, for example, using the 4D+RCS map (5D reflections list) corresponding to a radar frame, e.g., as described above.

For example, as shown in FIG. 5, the simulation path 502 may include determining a 4D energy map 513, for example, according to a path loss model, which may be applied to the 4D+RCS map (5D reflections list) 511, e.g., as described above.

For example, as shown in FIG. 5, the simulation path 502 may include determining a simulated 4D spectrum 517 by performing convolutions of the 4D energy map 513 with the PSFs corresponding to the range, Doppler, azimuth, and elevation domains, e.g., as described above.

For example, as shown in FIG. 5, the simulation path 502 may include determining a first convolution result 515, for example, based on a first multi-dimensional convolution of the 4D energy map 513 with at least one first PSF configured according to range and Doppler processing procedures of the simulated radar system.

For example, as shown in FIG. 5, the simulation path 502 may include determining the simulated 4D spectrum 517, for example, based on a second convolution result, which may be based on a second multi-dimensional convolution of the first convolution result 515 with at least one second PSF configured according to azimuth and elevation processing procedures of the simulated radar system.

For example, as shown in FIG. 5, the simulation path 502 may include determining an adjusted simulated 4D radar spectrum 519, for example, by adjusting the simulated 4D radar spectrum 517 according to one or more impairments, e.g., as described above.

For example, as shown in FIG. 5, the simulation path 502 may include determining a simulated radar point cloud 521, for example, based on the simulated 4D radar spectrum 519, e.g., as described above.

For example, as shown in FIG. 5, the simulation path 502 may include applying a detector on the 4D spectrum 519, for example, to output the simulated radar point cloud 521.

For example, as shown in FIG. 5, the simulation path 502 may utilize a scene simulator, e.g., the scene simulator 119 (FIG. 1), to provide the 5D reflections list 511, e.g., including the R-D-Az-El-RCS dimensions. For example, as shown in FIG. 5, the simulation path 502 may utilize the 5D reflections list 511 and parameters of the radar design, e.g., which may be represented by the associated 4D PSF and/or other parameters, to generate an estimation of the radar point cloud 521, e.g., as described above.

For example, as shown in FIG. 5, the simulation path 504 may be performed as part of a full time-space domain simulation for a single radar frame.

For example, as shown in FIG. 5, the simulation path 504 may require simulation of the transmission and reception of the wide band radar signals, which, in turn, may require significant computational effort, e.g., in order to generate the 4D spectrum (range, Doppler, AZ, EL).

For example, as shown in FIG. 5, the simulation path 504 may use a scene simulator to perform simulation of the channel and propagation, for example, from each Tx antenna, to each reflector, and then from each reflector to each Rx antenna.

For example, as shown in FIG. 5, the simulation path 504 may utilize the scene simulator and the channel simulator to provides a waveform, e.g., into each Rx antenna port, which may be processed, e.g., according to the full radar processing flow, to provide the radar point cloud.

For example, as shown in FIG. 5, the simulation path 504 may include processing the Rx signals using range pulse compression, Doppler processing and AoA processing (beamforming).

For example, as shown in FIG. 5, the simulation path 504 may include applying a detector on the 4D spectrum, for example, to output the point cloud.

For example, as shown in FIG. 5, the azimuth and/or elevation convolutions in simulation path 502 may be utilized, for example, to replace the spatial transmission (Tx signal) and/or the beamforming operations of the simulation path 504.

For example, as shown in FIG. 5, the range and/or Doppler convolutions in simulation path 502 may be utilized, for example, to replace the range pulse compression and/or the Doppler processor operations of the simulation path 504.

In one example, one or more attributes of the simulation path 502 may be compared to the attributes of the simulation path 504, e.g., as follows:

TABLE 2

| Type | Input | Processing | Output |
|---|---|---|---|
| Complete Radar | Received | Radar signal | Point cloud |
| signal simulation | sampled | processing | |
| | reflections from | as done in a | |
| | the scene to each | product sensor | |
| | and every Rx | | |
| | antenna element | | |
| Fast Radar | 5D reflections list | Implementing 4D | Estimated point |
| Simulation | | PSF and detector | cloud |

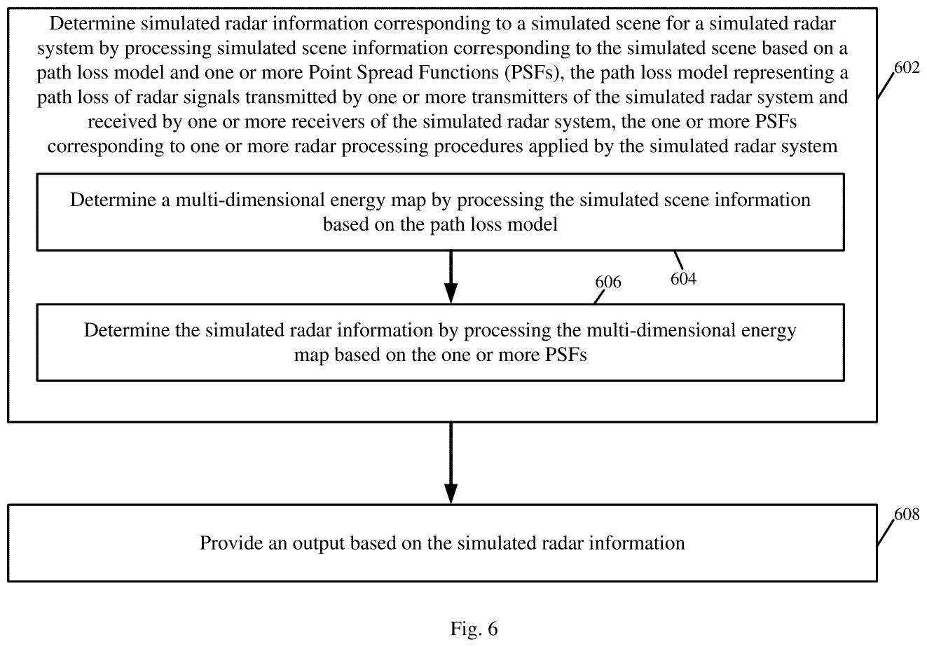

Reference is made to FIG. 6, which illustrates a method of radar simulation, in accordance with some demonstrative aspects. For example, simulator 102 (FIG. 1), radar simulator 110 (FIG. 1), and/or radar simulator 210 (FIG. 2) may be configured to implement one or more operations and/or functionalities according to the method of FIG. 6.

In some demonstrative aspects, as indicated at block 602, the method may include determining simulated radar information corresponding to a simulated scene for a simulated radar system, for example, by processing simulated scene information corresponding to the simulated scene based on a path loss model and one or more Point Spread Functions (PSFs). For example, the path loss model may represent a path loss of radar signals transmitted by one or more transmitters of the simulated radar system and received by one or more receivers of the simulated radar system. For example, the one or more PSFs may correspond to one or more radar processing procedures applied by the simulated radar system. For example, radar simulator 110 (FIG. 1) may be configured to determine the simulated radar information 139 (FIG. 1) corresponding to the simulated scene for the simulated radar system, for example, by processing simulated scene information 131 (FIG. 1) corresponding to the simulated scene based on a path loss model and one or more Point Spread Functions (PSFs), e.g., as described above.

In some demonstrative aspects, as indicated at block 604, determining the simulated radar information corresponding to the simulated scene may include determining a multi-dimensional energy map, for example, by processing the simulated scene information based on the path loss model. For example, radar simulator 110 (FIG. 1) may be configured to determine the multi-dimensional energy map, for example, by processing the simulated scene information 131 (FIG. 1) based on the path loss model, e.g., as described above.

In some demonstrative aspects, as indicated at block 606, determining the simulated radar information corresponding to the simulated scene may include determining the simulated radar information, for example, by processing the multi-dimensional energy map based on the one or more PSFs. For example, radar simulator 110 (FIG. 1) may be configured to determine the simulated radar information 139 (FIG. 1), for example, by processing the multi-dimensional energy map based on the one or more PSFs, e.g., as described above.

In some demonstrative aspects, as indicated at block 608, the method may include providing an output based on the simulated radar information. For example, radar simulator 110 (FIG. 1) may be configured to provide output information 133 (FIG. 1), for example, based on the simulated radar information 139 (FIG. 1), e.g., as described above.

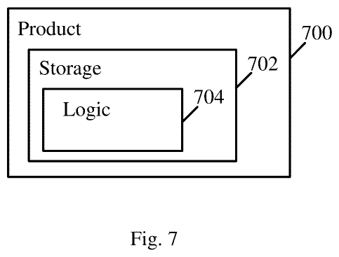

Reference is made to FIG. 7, which schematically illustrates a product of manufacture 700, in accordance with some demonstrative aspects. Product 700 may include one or more tangible computer-readable (“machine-readable”) non-transitory storage media 702, which may include computer-executable instructions, e.g., implemented by logic 704, operable to, when executed by at least one computer processor, enable the at least one computer processor to implement one or more operations at simulator 102 (FIG. 1), radar simulator 110 (FIG. 1), and/or radar simulator 210 (FIG. 2); to cause simulator 102 (FIG. 1), radar simulator 110 (FIG. 1), and/or radar simulator 210 (FIG. 2) to perform, trigger and/or implement one or more operations and/or functionalities; and/or to perform, trigger and/or implement one or more operations and/or functionalities described with reference to the FIGS. 1-6, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 700 and/or machine readable storage media 702 may include one or more types of computer-readable storage media capable of storing data, including volatile memory, non-volatile memory, removable or non-removable memory, erasable or non-erasable memory, writeable or re-writeable memory, and the like. For example, machine readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric: memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes a product comprising one or more tangible computer-readable non-transitory storage media comprising instructions operable to, when executed by at least one computer processor, enable the at least one processor to cause a radar simulator to determine simulated radar information corresponding to a simulated scene for a simulated radar system by processing simulated scene information corresponding to the simulated scene based on a path loss model and one or more Point Spread Functions (PSFs), the path loss model representing a path loss of radar signals transmitted by one or more transmitters of the simulated radar system and received by one or more receivers of the simulated radar system, the one or more PSFs corresponding to one or more radar processing procedures applied by the simulated radar system; and provide an output based on the simulated radar information.

Example 2 includes the subject matter of Example 1, and optionally, wherein the instructions, when executed, cause the radar simulator to determine a multi-dimensional energy map by processing the simulated scene information based on the path loss model; and determine the simulated radar information by processing the multi-dimensional energy map based on the one or more PSFs.

Example 3 includes the subject matter of Example 2, and optionally, wherein the instructions, when executed, cause the radar simulator to determine the simulated radar information by applying one or more multi-dimensional convolutions to the multi-dimensional energy map based on the one or more PSFs.

Example 4 includes the subject matter of Example 3, and optionally, wherein the instructions, when executed, cause the radar simulator to determine a first convolution result based on a first multi-dimensional convolution of the multi-dimensional energy map with at least one first PSF, the at least one first PSF configured according to one or more first processing procedures of the simulated radar system; and determine the simulated radar information based on a second convolution result, the second convolution result based on a second multi-dimensional convolution of the first convolution result with at least one second PSF, the at least one second PSF configured according to one or more second processing procedures of the simulated radar system.

Example 5 includes the subject matter of Example 4, and optionally, wherein the at least one first PSF is configured according to at least one of a range processing procedure of the simulated radar system or a Doppler processing procedure of the simulated radar system, wherein the at least one second PSF is configured according to at least one of an azimuth processing procedure of the simulated radar system or an elevation processing procedure of the simulated radar system.

Example 6 includes the subject matter of any one of Examples 3-5, and optionally, wherein the instructions, when executed, cause the radar simulator to configure the one or more multi-dimensional convolutions comprising at least one sparse convolution.

Example 7 includes the subject matter of any one of Examples 2-6, and optionally, wherein the instructions, when executed, cause the radar simulator to determine a simulated radar spectrum by processing the multi-dimensional energy map based on the one or more PSFs; determine an adjusted simulated radar spectrum by adjusting the simulated radar spectrum according to one or more adjustment models; and determine the simulated radar information based on the adjusted simulated radar spectrum.

Example 8 includes the subject matter of Example 7, and optionally, wherein the one or more adjustment models comprises a noise adjustment model configured to model noise affecting the simulated radar system.

Example 9 includes the subject matter of Example 7 or 8, and optionally, wherein the one or more adjustment models comprises a phase noise adjustment model configured to model phase noise affecting the simulated radar system.

Example 10 includes the subject matter of any one of Examples 7-9, and optionally, wherein the one or more adjustment models comprises a Transmit to Receive (Tx-RX) leakage adjustment model configured to model a Tx-Rx leakage of the simulated radar system.

Example 11 includes the subject matter of any one of Examples 7-10, and optionally, wherein the one or more adjustment models comprises an interference model configured to model interference affecting the simulated radar system.

Example 12 includes the subject matter of any one of Examples 7-11, and optionally, wherein the one or more adjustment models comprises a weather model configured to model one or more weather conditions affecting the simulated radar system.

Example 13 includes the subject matter of any one of Examples 7-12, and optionally, wherein the instructions, when executed, cause the radar simulator to determine the simulated radar information by applying a detection mechanism to the adjusted simulated radar spectrum.

Example 14 includes the subject matter of any one of Examples 2-13, and optionally, wherein the instructions, when executed, cause the radar simulator to determine the multi-dimensional energy map according to a ray-tracing mechanism.

Example 15 includes the subject matter of any one of Examples 2-14, and optionally, wherein the multi-dimensional energy map comprises a four-dimensional (4D) energy map comprising a range dimension, a Doppler dimension, an azimuth dimension, and an elevation dimension.

Example 16 includes the subject matter of any one of Examples 1-15, and optionally, wherein the one or more PSFs comprises at least one PSF based on at least one of a range processing procedure of the simulated radar system or a Doppler processing procedure of the simulated radar system.

Example 17 includes the subject matter of any one of Examples 1-16, and optionally, wherein the one or more PSFs comprises a PSF based on at least one of an azimuth processing procedure of the simulated radar system or an elevation processing procedure of the simulated radar system.

Example 18 includes the subject matter of any one of Examples 1-17, and optionally, wherein the instructions, when executed, cause the radar simulator to configure the path loss model based on one or more radar communication settings to configure communication of the radar signals by the simulated radar system.

Example 19 includes the subject matter of Example 18, and optionally, wherein the one or more radar communication settings comprises at least one of a Transmit (Tx) power to transmit the radar signals, a Tx antenna pattern of the simulated radar system, a Receive (Rx) antenna pattern of the simulated radar system, a radar frame structure for transmission of the radar signals, or a Tx method for transmission of the radar signals.

Example 20 includes the subject matter of any one of Examples 1-19, and optionally, wherein the instructions, when executed, cause the radar simulator to configure the path loss model based on installation information defining at least one of an installation location or an installation orientation of one or more antennas of the simulated radar system.

Example 21 includes the subject matter of any one of Examples 1-20, and optionally, wherein the instructions, when executed, cause the radar simulator to configure the path loss model based on one or more interference conditions for the simulated scene.

Example 22 includes the subject matter of any one of Examples 1-21, and optionally, wherein the instructions, when executed, cause the radar simulator to configure the path loss model based on one or more weather conditions for the simulated scene.

Example 23 includes the subject matter of any one of Examples 1-22, and optionally, wherein the instructions, when executed, cause the radar simulator to configure the one or more PSFs based on one or more settings of the simulated radar system.

Example 24 includes the subject matter of any one of Examples 1-23, and optionally, wherein the instructions, when executed, cause the radar simulator to configure the one or more PSFs based on at least one of a processing window setting of the simulated radar system, a signal bandwidth setting of the simulated radar system, a Pulse Repetition Interval (PRI) setting of the simulated radar system, a number-of-pulses-per-frame setting of the simulated radar system, a frame length setting of the simulated radar system, or an array aperture setting of the simulated radar system.

Example 25 includes the subject matter of any one of Examples 1-24, and optionally, wherein the instructions, when executed, cause the radar simulator to provide a user interface to receive simulation setting information from a user, the simulation setting information to define one or more settings of the simulated radar system; and determine the simulated radar information based on the simulation setting information.

Example 26 includes the subject matter of Example 25, and optionally, wherein the instructions, when executed, cause the radar simulator to configure at least one PSF of the one or more PSFs based on the simulation setting information.

Example 27 includes the subject matter of Example 25 or 26, and optionally, wherein the instructions, when executed, cause the radar simulator to configure the path loss model based on the simulation setting information.

Example 28 includes the subject matter of any one of Examples 1-27, and optionally, wherein the simulated scene information comprises a five-dimensional (5D) energy map comprising a range dimension, a Doppler dimension, an azimuth dimension, an elevation dimension, and a Radar Cross-Section (RCS) dimension.

Example 29 includes the subject matter of any one of Examples 1-28, and optionally, wherein the instructions, when executed, cause the radar simulator to provide the output in compliance with one or more real-time radar system latency constraints for the simulated radar system.

Example 30 includes the subject matter of any one of Examples 1-29, and optionally, wherein the simulated radar information comprises simulated radar point cloud information corresponding to the simulated scene.

Example 31 includes the subject matter of any one of Examples 1-30, and optionally, wherein the simulated radar information comprises at least one of an object list, a tracked object list, bounding box information of one or more bounding boxes, classification information to classify one or more objects, an accumulated point cloud, a multi-frame filtered point cloud, or drivable space information.

Example 32 includes the subject matter of any one of Examples 1-31, and optionally, wherein the instructions, when executed, cause the radar simulator to provide the output comprising simulated radar data to be provided by a Software-in-the Loop (SIL) simulator to a controller under test.

Example 33 includes the subject matter of any one of Examples 1-31, and optionally, wherein the instructions, when executed, cause the radar simulator to provide the output comprising simulated radar data to be provided by a Hardware-in-the Loop (HIL) simulator to a controller under test.

Example 34 includes the subject matter of any one of Examples 1-31, and optionally, wherein the instructions, when executed, cause the radar simulator to provide the output comprising simulated radar data configured to train an Artificial Intelligence (AI) based algorithm.

Example 35 includes the subject matter of any one of Examples 1-34, and optionally, wherein the simulated radar system comprises a Multiple-Input-Multiple-Output (MIMO) radar system comprising a plurality of transmit antennas and a plurality of receive antennas.

Example 36 includes a testing simulator comprising a scene generator to generate simulated scene information corresponding to a simulated scene based on control information from a controller under test; and a radar simulator configured to provide simulated radar data for the controller under test based on the simulated scene information, the radar simulator configured to determine simulated radar information corresponding to the simulated scene by processing the simulated scene information based on a path loss model and one or more Point Spread Functions (PSFs), the path loss model representing a simulated path loss of radar signals transmitted by one or more transmitters of a simulated radar system and received by one or more receivers of the simulated radar system according to the simulated scene, the one or more PSFs corresponding to one or more radar processing procedures applied by the simulated radar system, wherein the simulated radar data is based on the simulated radar information.

Example 37 includes the testing simulator according to Example 36, and optionally, wherein the radar simulator is configured according to the subject matter of any of Examples 1-35.

Example 38 includes an apparatus comprising means for performing any of the described operations of any of Examples 1-37.

Example 39 includes a radar simulator configured to perform any of the described operations of any of Examples 1-37.

Example 40 includes a machine-readable medium that stores instructions for execution by a processor to perform any of the described operations of any of Examples 1-37.

Example 41 includes an apparatus comprising a memory; and processing circuitry configured to perform any of the described operations of any of Examples 1-37.

Example 42 includes a method including any of the described operations of any of Examples 1-37.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A product comprising one or more tangible computer-readable non-transitory storage media comprising instructions operable to, when executed by at least one computer processor, enable the at least one processor to cause a radar simulator to:
determine simulated radar information corresponding to a simulated scene for a simulated radar system by processing simulated scene information corresponding to the simulated scene based on a path loss model and one or more Point Spread Functions (PSFs), the path loss model representing a path loss of radar signals transmitted by one or more transmitters of the simulated radar system and received by one or more receivers of the simulated radar system, the one or more PSFs corresponding to one or more radar processing procedures applied by the simulated radar system; and
provide an output based on the simulated radar information.

2. The product of claim 1, wherein the instructions, when executed, cause the radar simulator to:
determine a multi-dimensional energy map by processing the simulated scene information based on the path loss model; and
determine the simulated radar information by processing the multi-dimensional energy map based on the one or more PSFs.

3. The product of claim 2, wherein the instructions, when executed, cause the radar simulator to determine the simulated radar information by applying one or more multi-dimensional convolutions to the multi-dimensional energy map based on the one or more PSFs.

4. The product of claim 3, wherein the instructions, when executed, cause the radar simulator to:
determine a first convolution result based on a first multi-dimensional convolution of the multi-dimensional energy map with at least one first PSF, the at least one first PSF configured according to one or more first processing procedures of the simulated radar system; and
determine the simulated radar information based on a second convolution result, the second convolution result based on a second multi-dimensional convolution of the first convolution result with at least one second PSF, the at least one second PSF configured according to one or more second processing procedures of the simulated radar system.

5. The product of claim 4, wherein the at least one first PSF is configured according to at least one of a range processing procedure of the simulated radar system or a Doppler processing procedure of the simulated radar system, wherein the at least one second PSF is configured according to at least one of an azimuth processing procedure of the simulated radar system or an elevation processing procedure of the simulated radar system.

6. The product of claim 2, wherein the instructions, when executed, cause the radar simulator to:
determine a simulated radar spectrum by processing the multi-dimensional energy map based on the one or more PSFs;
determine an adjusted simulated radar spectrum by adjusting the simulated radar spectrum according to one or more adjustment models; and
determine the simulated radar information based on the adjusted simulated radar spectrum.

7. The product of claim 6, wherein the one or more adjustment models comprises a noise adjustment model configured to model noise affecting the simulated radar system.

8. The product of claim 6, wherein the one or more adjustment models comprises at least one of a phase noise adjustment model configured to model phase noise affecting the simulated radar system, a Transmit to Receive (Tx-RX) leakage adjustment model configured to model a Tx-Rx leakage of the simulated radar system, an interference model configured to model interference affecting the simulated radar system, or a weather model configured to model one or more weather conditions affecting the simulated radar system.

9. The product of claim 6, wherein the instructions, when executed, cause the radar simulator to determine the simulated radar information by applying a detection mechanism to the adjusted simulated radar spectrum.

10. The product of claim 2, wherein the instructions, when executed, cause the radar simulator to determine the multi-dimensional energy map according to a ray-tracing mechanism.

11. The product of claim 2, wherein the multi-dimensional energy map comprises a four-dimensional (4D) energy map comprising a range dimension, a Doppler dimension, an azimuth dimension, and an elevation dimension.

12. The product of claim 1, wherein the one or more PSFs comprises at least one PSF based on at least one of a range processing procedure of the simulated radar system or a Doppler processing procedure of the simulated radar system.

13. The product of claim 1, wherein the one or more PSFs comprises a PSF based on at least one of an azimuth processing procedure of the simulated radar system or an elevation processing procedure of the simulated radar system.

14. The product of claim 1, wherein the instructions, when executed, cause the radar simulator to configure the path loss model based on one or more radar communication settings to configure communication of the radar signals by the simulated radar system.

15. The product of claim 14, wherein the one or more radar communication settings comprises at least one of a Transmit (Tx) power to transmit the radar signals, a Tx antenna pattern of the simulated radar system, a Receive (Rx) antenna pattern of the simulated radar system, a radar frame structure for transmission of the radar signals, or a Tx method for transmission of the radar signals.

16. The product of claim 1, wherein the instructions, when executed, cause the radar simulator to configure the path loss model based on at least one of: installation information defining at least one of an installation location or an installation orientation of one or more antennas of the simulated radar system; one or more interference conditions for the simulated scene; or one or more weather conditions for the simulated scene.

17. The product of claim 1, wherein the instructions, when executed, cause the radar simulator to configure the one or more PSFs based on one or more settings of the simulated radar system.

18. The product of claim 1, wherein the instructions, when executed, cause the radar simulator to configure the one or more PSFs based on at least one of a processing window setting of the simulated radar system, a signal bandwidth setting of the simulated radar system, a Pulse Repetition Interval (PRI) setting of the simulated radar system, a number-of-pulses-per-frame setting of the simulated radar system, a frame length setting of the simulated radar system, or an array aperture setting of the simulated radar system.

19. The product of claim 1, wherein the instructions, when executed, cause the radar simulator to:
provide a user interface to receive simulation setting information from a user, the simulation setting information to define one or more settings of the simulated radar system; and
determine the simulated radar information based on the simulation setting information.

20. The product of claim 19, wherein the instructions, when executed, cause the radar simulator to configure at least one PSF of the one or more PSFs based on the simulation setting information.

21. The product of claim 19, wherein the instructions, when executed, cause the radar simulator to configure the path loss model based on the simulation setting information.

22. The product of claim 1, wherein the simulated scene information comprises a five-dimensional (5D) energy map comprising a range dimension, a Doppler dimension, an azimuth dimension, an elevation dimension, and a Radar Cross-Section (RCS) dimension.

23. The product of claim 1, wherein the instructions, when executed, cause the radar simulator to provide the output in compliance with one or more real-time radar system latency constraints for the simulated radar system.

24. The product of claim 1, wherein the simulated radar information comprises simulated radar point cloud information corresponding to the simulated scene.

25. The product of claim 1, wherein the simulated radar information comprises at least one of an object list, a tracked object list, bounding box information of one or more bounding boxes, classification information to classify one or more objects, an accumulated point cloud, a multi-frame filtered point cloud, or drivable space information.

26. The product of claim 1, wherein the instructions, when executed, cause the radar simulator to provide the output comprising simulated radar data to be provided by a simulator to a controller under test.

27. The product of claim 1, wherein the instructions, when executed, cause the radar simulator to provide the output comprising simulated radar data configured to train an Artificial Intelligence (AI) based algorithm.

28. A testing simulator comprising:
a scene generator to generate simulated scene information corresponding to a simulated scene based on control information from a controller under test; and
a radar simulator configured to provide simulated radar data for the controller under test based on the simulated scene information, the radar simulator configured to determine simulated radar information corresponding to the simulated scene by processing the simulated scene information based on a path loss model and one or more Point Spread Functions (PSFs), the path loss model representing a simulated path loss of radar signals transmitted by one or more transmitters of a simulated radar system and received by one or more receivers of the simulated radar system according to the simulated scene, the one or more PSFs corresponding to one or more radar processing procedures applied by the simulated radar system, wherein the simulated radar data is based on the simulated radar information.

29. The testing simulator of claim 28, wherein the radar simulator is configured to:
determine a multi-dimensional energy map by processing the simulated scene information based on the path loss model; and
determine the simulated radar information by processing the multi-dimensional energy map based on the one or more PSFs.
